(19) United States
(12) Patent Application Publication
(10) Pub. No.: US 2009/0184895 A1
(43) Pub. Date: Jul. 23, 2009

(54) PLASMA DISPLAY PANEL AND DISPLAY DEVICE HAVING THE SAME

(75) Inventors: Norihiro Uemura, Hitachi (JP); Shunichiro Nobuki, Kokubunji (JP); Masakazu Sagawa, Inagi (JP); Shirun Ho, Tokyo (JP); Keizo Suzuki, Kodaira (JP); Yoshiro Mikami, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi,Ltd.

(21) Appl. No.: 12/344,672

(22) Filed: Dec. 29, 2008

(30) Foreign Application Priority Data
Jan. 17, 2008 (JP) 2008-007876

(51) Int. Cl. G09G 3/28

(52) U.S. Cl. 345/60

(57) ABSTRACT

A high-definition, high-quality, and high-contrast PDP that features high brightness, guaranteed long life, and stable driving, is provided by improving the time-dependent degradation of address discharge delay. The PDP includes: a front substrate having bus electrodes, and sustain discharge electrodes extending in a lateral direction of the bus electrodes to form display lines; a back substrate having address electrodes facing the sustain discharge electrodes in the lateral direction of the bus electrodes; and discharge cells formed between the substrates. Each of the discharge cells includes a sustain discharge cell and a priming discharge cell, in which a protruding electrode is formed to extend in a direction opposite to the discharge gap from the bus electrode, and a predetermined space is provided between the two cells to supply priming. The shape and size of the space are optimized so that the sustain discharge does not spread to the address discharge cell through the space.

### CLAIM OF PRIORITY

The present application claims priority from Japanese Patent Application JP 2008-007876 filed on Jan. 17, 2008, the content of which is hereby incorporated by reference into this application.

### FIELD OF THE INVENTION

The present invention relates to a plasma display panel (hereinafter also referred to as a plasma panel or PDP). More specifically, the present invention relates to a plasma panel structure capable of realizing a high quality PDP by reducing address discharge delay and degradation thereof, and a plasma display device including a drive unit.

### BACKGROUND OF THE INVENTION

Plasma display devices have recently attracted attention as large-area flat color display devices. The PDP can be classified into two types, DC (direct current) type and AC (alternating current) type, from the difference in the structures and drive methods. Particularly, the AC surface-discharge type PDP, which is an AC-driven plasma display device for generating display discharge between electrodes provided on a single substrate, is the most commonly used system due to its simple structure and high reliability. An exemplary embodiment of a conventional AC surface-discharge type PDP will be described below.

FIG. 2 is an exploded perspective view showing, by way of example, a part of the structure of a typical AC surface-discharge type PDP. In the figure, the PDP has a front substrate 21 and a back substrate 28, which are glass substrates integrally attached to each other. On the side of the back substrate 28, phosphor layers 32 of red (R), green (G), and blue (B) are formed to constitute the panel as a reflective PDP. The front substrate 21 has pairs of sustain-discharge electrodes (also referred to as display electrodes) formed in parallel on a surface thereof facing the back substrate 28 with a certain distance between the two substrates. The pairs of sustain-discharge electrodes are structured to include transparent common electrodes (hereinafter simply referred to as X electrodes) (22-1, 22-2, and so on), and transparent independent electrodes (hereinafter simply referred to as Y electrodes or scan electrodes) (23-1, 23-2, and so on).

Further, the X electrodes (22-1, 22-2, and so on) are provided with opaque X bus electrodes (24-1, 24-2, and so on), and the Y electrodes (23-1, 23-2, and so on) are provided with opaque Y bus electrodes (25-1, 25-2, and so on). The X and Y bus electrodes are formed to extend in the direction of the arrow D2 in FIG. 2 (or in the horizontal row direction), in order to increase the conductivity of the X and Y electrodes. Further, the X electrodes (22-1, 22-2, and so on), Y electrodes (23-1, 23-2, and so on), X bus electrodes (24-1, 24-2, and so on), and Y bus electrodes (25-1, 25-2, and so on) are all insulated from discharge due to the AC drive. More specifically, these electrodes are covered by a dielectric layer 26 which is typically formed from a low-melting glass layer. The dielectric layer 26 is covered by a protective layer 27.

The back substrate 28 has address electrodes (hereinafter simply referred to as A electrodes) 29 on a surface thereof facing the front substrate 21, orthogonally intersect the X electrodes (22-1, 22-2, and so on) and Y electrodes (23-1, 23-2, and so on) of the front substrate 21. The A electrodes 29 are covered by a dielectric layer 30. The A electrodes 29 are formed to extend in the direction of the arrow D1 in FIG. 2 (or in the vertical column direction). On the dielectric layer 30, ribs 31 are formed to divide between the A electrodes 29, in order to prevent discharge spread (namely, to determine discharge areas). The phosphor layers 32 for emitting red light, green light, and blue light, are sequentially applied as stripes so as to coat the groove surfaces between the ribs 31.

FIG. 3 is a cross-sectional view showing a key part of the PDP structure viewed from the direction of the arrow D2 in FIG. 2. The figure shows one discharge cell which is the minimum unit of pixel. The dashed lines in the figure indicate the approximate positions of the discharge cell boundaries. Reference numeral 33 denotes a discharge space that is filled with discharge gas for generating plasma. When a voltage is applied between the electrodes, plasma 10 is generated by ionization of the discharge gas. FIG. 3 schematically shows the state in which the plasma 10 is generated. Ultraviolet light from the plasma 10 excites the phosphor layer 32 to emit light. The light emitted from the phosphor layer 32 passes through the front substrate 21. In this way, the lights emitted from the respective phosphor layers 32 constitute an image on a display screen.

FIG. 4 schematically shows the movement of charged particles (or particles having a positive or negative charge) in the plasma 10 in FIG. 3. In FIG. 4, reference numeral 3 denotes a particle having a negative charge (for example, an electron), reference numeral 4 denotes a particle having a positive charge (for example, a positive ion), reference numeral 5 denotes a positive wall charge, and reference numeral 6 denotes a negative wall charge. The figure shows the charge state at a certain point of time during driving of the PDP, in which the charge distribution has no particular meaning.

FIG. 4 is a schematic diagram showing, by way of example, a state in which discharge is started by applying a negative voltage to the Y electrode 23-1 and a (relatively) positive voltage to both the A electrode 29 and the X electrode 22-1, and then the discharge has ceased. As a result, formation of wall charges (which is called “address”) has been performed to help start a discharge between the Y electrode 23-1 and the X electrode 22-1. When an appropriate reverse voltage is applied between the Y electrode 23-1 and the X electrode 22-1 in this state, a discharge occurs in a discharge space between the two electrodes through the dielectric layer 26 (and the protective layer 27). After cessation of the discharge, when the voltage applied between the Y electrode 23-1 and the X electrode 22-1 is reversed, another discharge occurs. The discharge can be continuously produced by repeating the reversal of the polarity of the voltage applied between the X and Y electrodes. This is called “sustain discharge”.

FIGS. 5A, 5B, 5C are diagrams showing an operation in one TV field period for displaying an image on the PDP shown in FIG. 2. FIG. 5A is a time chart. As indicated by (I) in FIG. 5A, one TV field period 40 is divided into subfields 41 to 48 each having plural different numbers of light emission. The gray scale is represented by selecting between light emission and non-light emission for each subfield. As indicated by (II) in FIG. 5A, each subfield includes a reset period 49, an address discharge period 50 for determining a light emission cell, and a sustain discharge period 51.

FIG. 5B shows voltage waveforms applied to the A electrode, X electrode, and Y electrode during the address discharge period 50 in FIG. 5A. A waveform 52 is a voltage waveform applied to a single A electrode in the address discharge period 50. A waveform 53 is a voltage waveform applied to the X electrode. Waveforms 54, 55 are voltage waveforms applied to the i-th and (i+1)th Y electrodes. The voltages applied to the respective electrodes are denoted by V0, V1, V2 (V). In FIG. 5B, the width of a voltage pulse applied to the A electrode is given by tₐ.

In FIG. 5B, when a scan pulse 56 is applied to the i-th Y electrode, an address discharge occurs in a cell at the intersection between the i-th Y electrode and the A electrode 29. However, even when the scan pulse 56 is applied to the i-th Y electrode, the address discharge does not occur when the A electrode 29 is at a ground potential (GND). In this way, the scan pulse 56 is applied once to the Y electrode in the address discharge period 50. In response to the scan pulse, a light emission cell of the A electrode 29 is supplied with the voltage V0, and a non-light emission cell of the A electrode 29 is set at the ground potential. In the discharge cell in which the address discharge has occurred, the charges generated by the discharge are formed on a surface of the dielectric layer covering the Y electrodes and the protective layer covering the dielectric layer. With the help of the electric field generated by the charge, it is possible to control ON and OFF of the sustain discharge which will be described later. In other words, the discharge cell in which the address discharge has occurred becomes a light emission cell, and the others become non-light emission cells.

FIG. 5C shows voltage pulses simultaneously applied to the X and Y electrodes, which are the sustain-discharge electrodes, during the sustain discharge period 51 in FIG. 5A. A voltage waveform 58 is applied to the X electrode and a voltage waveform 59 is applied to the Y electrode. Voltage pulses V3 (V) of the same polarity are applied alternately to the X electrode and the Y electrode, so that the relative voltage between the X and Y electrodes is repeatedly reversed. The discharge generated in the discharge gas between the X and Y electrodes during the sustain discharge period 51, is referred to as sustain discharge. Here, the sustain discharge is alternately performed in the form of pulses.

In the conventional DC type PDP, there have been proposed structures using an auxiliary discharge cell. JP-A No. 211831/1987 proposes a structure having an auxiliary discharge cell and a display discharge cell with a space provided between the two cells, to make it easier to generate display discharge by auxiliary discharge. JP-A No. 169038/1992 proposes a structure having an auxiliary cell and a space (a priming path) for introducing space charges generated by discharge. Further, JP-A No. 182978/1995 proposes a structure having an auxiliary cell and a discharge hole to simplify the panel structure. Still further, JP-A No. 83571/1996 proposes a structure having a dummy auxiliary cell to equalize the discharge of the auxiliary cell.

Also in the AC type PDP, there have been proposed structures using a priming-discharge cell. JP-A Nos. 108023/2006 and 59587/2006 propose a structure having a main discharge cell and a priming discharge cell, in which a priming electrode is provided in a front or back substrate.

JP-A Nos. 217458/2003, 251628/2005, and 135732/2005 propose structures having a display discharge cell and an address discharge cell, in which a communication portion is provided between the discharge cell and the address discharge cell. Particularly, JP-A No. 251628/2005 proposes a structure in which a space is formed not only between the display discharge cells but also between the address discharge cells.

### SUMMARY OF THE INVENTION

Address discharge delay is a problem to be overcome in order to achieve a low-power consumption, high-definition, and high-quality AC type PDP that features high brightness, guaranteed long life, and stable driving. When the address discharge delay increases, an address discharge failure occurs. The following sustain discharge is not performed, and then flickering occurs on a display screen. The address discharge delay further increases when the PDP is driven for a long time, which is a problem of time-dependent degradation. In other words, when the PDP is lit for a long time, flickering occurs on the display screen, resulting in degradation of the quality of the PDP.

As described in JP-A Nos. 108023/2006 and 59587/2006, the address discharge delay can be improved by providing a priming discharge cell and a priming electrode to generate priming discharge and thereby reducing the discharge delay. However, it is necessary to provide a driving circuit to supply driving voltage to be applied to the priming electrode. This leads to a cost increase.

Further, as described in JP-A Nos. 217458/2003 and 251628/2005, when an address discharge takes place only in an individually formed address discharge cell, the movement of charged particles from the address discharge cell to the display discharge cell is not sufficiently performed. As a result, the discharge is unstable.

Still further, as described in JP-A No. 135732/2005, the charged particles diffuse into the display discharge cell through a vertical continuous opening, which acts as priming to surely cause a discharge even with short scan pulses. However, this does not function well unless the size and shape of the space between the address discharge cell and display discharge cell are optimized. More specifically, when the space is too narrow, the movement of the charged particles is not sufficient to perform address discharge, leading to an address failure. On the other hand, when the space is too wide, the discharge spreads even to the priming discharge cell during the sustain discharge, and the MgO surface of the priming discharge cell is degraded. As a result, the effect of the priming discharge cell disappears. Similarly when the space is too wide, the particles generated in the priming discharge cell erase the charges that have been formed by the reset discharge in the sustain discharge cell. This presents a problem for the discharge of the sustain discharge cell.

The present invention is made in light of the above described circumstances, and the object is to provide a high-definition, high-contrast, and high-quality PDP that features high brightness, guaranteed long life, and stable driving, by improving the time-dependent degradation of address discharge delay.

Typical inventions disclosed in the present application will be outlined as follows.
(1) There is provided a plasma display panel including: a front substrate having bus electrodes, and pairs of sustain-discharge electrodes arranged parallel in a lateral direction of the bus electrodes to form display lines; a back substrate having address electrodes arranged to face the pairs of the sustain-discharge electrodes in the lateral direction of the bus electrodes; and plural discharge cells formed from the front substrate and the back substrate. The discharge cell is divided into a sustain discharge cell and a priming discharge cell by a rib. A predetermined space is formed between the rib and the front substrate. A protruding electrode is formed in the front substrate to extend from one of the paired discharge electrodes in the sustain discharge cell or from the bus electrode, to the side of the priming discharge cell through the space. The sustain discharge produced in the sustain discharge cell does not spread to the priming discharge cell through the space.
(2) In the plasma display panel described in the paragraph (1), a length of the space in the longitudinal direction of the bus electrode is given by w, and a height of the space from the front substrate toward the back substrate is given by h, where w>h, with w between 40% and 70% of an inside diameter of the rib and h between 5 μm and 50 μm.
(3) In the plasma display panel described in the paragraph (2), h is between 5 μm and 30 μm.
(4) In the plasma display panel described in any of the paragraphs (1) to (3), a width of the protruding electrode in the longitudinal direction of the bus electrode is larger than w.
(5) In the plasma display panel described in any of the paragraphs (1) to (4), the address electrode is formed so as to overlap with projection of the protruding electrode from the front substrate to the back substrate.
(6) In the plasma display panel described in any of the paragraphs (1) to (5), a cross sectional shape of the space is rectangular with smooth corners.
(7) In the plasma display panel described in the paragraph (1), the protruding electrode extends from the pair of the sustain-discharge electrodes.
(8) There is provided a plasma display panel including: a front substrate having bus electrodes, and pairs of sustain-discharge electrodes arranged parallel in a lateral direction of the bus electrodes to form display lines; a back substrate having address electrodes arranged to face the pairs of the sustain-discharge electrodes in the lateral direction of the bus electrodes; and plural discharge cells formed from the front substrate and the back substrate. The discharge cell is divided into a sustain discharge cell and a priming discharge cell by a rib. A predetermined space is formed between the rib and the front substrate. A protruding electrode is formed in the front substrate to extend from one of the paired discharge electrodes in the sustain discharge cell or from the bus electrode, to the side of the priming discharge cell through the space. A length of the space in the longitudinal direction of the bus electrode is given by w, and a height of the space from the front substrate toward the back substrate is given by h, where w>h, with w between 40% to 70% of an inside diameter of the rib and h between 5 μm and 50 μm.
(9) In the plasma display panel described in the paragraph (8), h is between 5 μm and 30 μm.
(10) In the plasma display panel described in the paragraph (8) or (9), a width of the protruding electrode in the longitudinal direction of the bus electrode is larger than w.
(11) In the plasma display panel described in any of the paragraphs (8) to (10), the address electrode is formed so as to overlap with projection of the protruding electrode from the front substrate toward the back substrate.
(12) In the plasma display panel described in any of the paragraphs (8) to (11), a cross sectional shape of the space is rectangular with smooth corners.
(13) In the plasma display panel described in the paragraph (8), the protruding electrode extends from the pair of the sustain-discharge electrodes.
(14) In the plasma display panel described in any of the paragraphs (1) to (13), a black absorption layer is provided in the priming discharge cell on the side of the front substrate.
(15) There is provided a plasma display panel including: a front substrate having bus electrodes, and pairs of sustain-discharge electrodes arranged parallel in a lateral direction of the bus electrodes to form display lines; a back substrate having address electrodes arranged to face the pairs of the sustain-discharge electrodes in the lateral direction of the bus electrodes; and plural discharge cells formed from the front substrate and the back substrate. The discharge cell is divided into a sustain discharge cell and a priming discharge cell by a rib. A predetermined space is formed between the rib and the front substrate. A protruding electrode is formed in the front substrate to extend from one of the paired discharge electrodes in the sustain discharge cell or from the bus electrode, to the side of the priming discharge cell through the space. A length of the space in a longitudinal direction of the bus electrode is given by w, and a height of the space from the front substrate toward the back substrate is given by h, where w>h. The cross-sectional area of the space is between 250 μm² and 4500 μm².
(16) In the plasma display panel described in the paragraph (15), h is between 5 μm and 50 μm.
(17) In the plasma display panel described in the paragraph (15), h is between 5 μm and 30 μm.

By applying the present invention, the time-dependent degradation of address discharge delay can be improved to provide a high-contrast and high quality PDP that features high brightness, guaranteed lifetime, and stable driving.

### BRIEF DESCRIPTION OF THE DRAWINGS

FIG. 1 is an exploded perspective view showing a part of the structure of a PDP of an embodiment according to the present invention;

FIG. 2 is an exploded perspective view showing a part of the structure of an AC surface-discharge type PDP of conventional structure;

FIG. 3 is a cross-sectional view of the PDP structure shown in FIG. 2;

FIG. 4 is a schematic diagram showing the movement of charged particles in plasma 10 shown in FIG. 3;

FIGS. 5A, 5B, 5C are diagrams showing the operation in one TV field period for displaying an image on a PDP;

FIG. 6 is a diagram showing a discharge cell of a PDP of an embodiment according to the present invention, or showing a part of the discharge cell;

FIG. 7 is a cross-sectional view taken along line V1-V1′ of FIG. 6;

FIG. 8 is a cross-sectional view taken along line H1-H1′ of FIG. 6;

FIG. 9 shows results of observing the discharge of priming discharge cell and the discharge of sustain discharge cell in a PDP of an embodiment according to the present invention;

FIG. 10 shows results of measuring t_da, t_tr, and t_ds by changing the height h of the space;

FIG. 11 shows results of lifetime test of a PDP of an embodiment according to the present invention;

FIG. 12 is a diagram showing a discharge cell of a PDP of an embodiment according to the present invention, or showing a part of the discharge cell;

FIG. 13 is a diagram showing another discharge cell of a PDP of an embodiment according to the present invention, or showing a part of the discharge cell;

FIG. 14 is a diagram showing still another discharge cell of a PDP of an embodiment according to the present invention, or showing a part of the discharge cell; and

FIG. 15 is a block diagram showing a display system using a PDP.

### DETAILED DESCRIPTION OF THE PREFERRED EMBODIMENTS

Hereinafter embodiments of the present invention will be described in detail with reference to the accompanying drawings. Throughout all the drawings for explaining the embodiments, the components having identical functions will be designated by the common reference numerals, and their repeated description will be omitted.

First, the address discharge delay will be described. Address discharge delay t_{d} is the time from when a voltage waveform is applied, to when an address discharge is generated. The address discharge delay is divided into two parts, formation delay t_{f} and statistical delay tₛ, and is defined as follows.

t_{d}=t_{f}+tₛ (Equation 1)

Here, the formation delay t_{f} is the time from when seed electrons are generated as seeds of discharge, to when the discharge is produced. The statistical delay tₛ is the time from when a discharge start voltage or more is applied between electrodes, to when the seed electrons are generated. When the same measurement is repeatedly performed, the address discharge delay varies and has a distribution. Thus, in order to obtain the discharge delay from the experimental results, typically the results of plural measurements are statistically processed to determine the formation delay until the start of the discharge distribution, as well as the statistical delay corresponding to the width of the discharge distribution, for the purpose of analysis. When all the discharges in the plural measurements do not take place within the time of the address pulse width, an address discharge failure occurs, and flickering occurs on the display screen. For this reason, all the discharges must take place within the address pulse.

Further, in the lifetime test in which the PDP is continuously driven and lit, the address discharge delay, in particular the statistical delay, greatly increases. As a result, the flickering occurs and even increases as the lightening time increases.

It is thought that the degradation in the lifetime test is caused by the following mechanism. That is, as described above, the statistical delay is the time from when the discharge start voltage or more is applied between the electrodes, to when the seed electrons are generated. The electrons captured by trap levels that lie between the valence band and the conduction band in MgO and slightly below the conduction band, are emitted to the discharge space by the field effect and the Auger process. Thus, the seed electrons are generated as the seeds of discharge. According to the lifetime test, the increase of the statistical delay could be caused by the fact that the number of trap levels in MgO decreases by bombardment of ions in plasma against the MgO surface, and that the number of seed electrons emitted from MgO decreases.

The degradation of the MgO surface by ion bombardment is mainly induced in the sustain discharge. While the discharge delay problem emerges in the address discharge. Thus, a priming discharge cell is provided to isolate the place in which an address discharge is generated, in order to avoid the degradation of the MgO surface by the sustain discharge. In this way, the electron emission from MgO is maintained, so that the discharge delay can be substantially improved. However, the total number of priming particles from the priming discharge cell is not enough to perform an address for the sustain discharge cell. For this reason, the address discharge in the sustain discharge cell is triggered by the priming particles to allow stable address discharge. In addition, the time-dependent degradation of discharge delay can also be improved.

Here, a description will be given of a discharge transition mechanism from the priming discharge cell to the sustain discharge cell. After the delay-time degradation occurs, MgO in the sustain discharge cell is degraded and the number of emitted seed electrons decreases. On the other hand, MgO in the priming discharge cell is hardly degraded with sufficient number of seed electrons emitted. When a voltage is applied between A and Y, the discharge is first started in the priming discharge cell. At this time, space charges generated by the discharge are sequentially attached to MgO of the priming discharge cell so as to deny the electrode potentials and the potentials of wall charges that have been formed by reset discharge.

The potential decreases in places where the wall charges of opposite polarity are formed by attachment of the space charges. Thus, the space charges sequentially attach to the side of the sustain discharge cell to which no wall charge of opposite polarity is attached yet. The discharge grows by secondary electrons emitted by bombardment of the space charges against the MgO surface. When the attachment of the space charges reaches the space between the priming discharge cell and the sustain discharge cell, or reaches the side of the sustain discharge cell, secondary electrons are generated in the space or in the sustain discharge cell, and thereby the discharge grows on the side of the sustain discharge cell. In this way, the discharge is transferred from the priming discharge cell to the sustain discharge cell. It should be noted that a certain amount of time is necessary to transfer the discharge as described above.

Consequently, the address discharge time lag in the sustain discharge cell is the sum of the discharge time lag in the priming discharge cell and the discharge transition period from the priming discharge cell to the sustain discharge cell. Here, the discharge transition period also includes the discharge grow time in the sustain discharge cell. If the discharge time lag is represented by t_{ds}, it can be expressed as follows:

t_{ds}=t_{ca}+tₜᵣ (Equation 2)

where t_{da} is the discharge time lag in the priming discharge cell, and tₜᵣ is the discharge transition period.

The discharge transition period tₜᵣ is largely dependent on the size and shape of the space between the priming discharge cell and the sustain discharge cell. In other words, the effect of the priming discharge cell does not function very well unless the size and shape of the space are optimized.

For example, when the space between the priming discharge cell and the sustain discharge cell is narrow, only an insufficient amount of charged particles is introduced into the sustain discharge cell, which is not enough to function as the trigger of discharge, so that the discharge delay is not improved. On the other hand, when the space is too large, the discharge spreads even to the priming discharge cell during the sustain discharge, so that the MgO surface of the priming discharge cell is degraded. The discharge delay of the priming discharge cell increases due to the degradation of the MgO surface. As a result, there is no effect of improving the time-dependent degradation of discharge delay in the sustain discharge cell. Further, the particles generated in the priming discharge cell erase the charges that have been formed by the reset discharge in the sustain discharge cell. The effective potential applied to the sustain discharge cell decreases. As a result, more time is necessary for discharge formation in the sustain discharge cell, and the discharge transition period increases.

In addition, even with the same cross-sectional area of the space viewed from the priming discharge cell to the sustain discharge cell, the way of spread of the sustain discharge to the priming discharge cell is different depending on whether the space extends in the longitudinal direction of the bus electrode (horizontally long), or the space extends perpendicularly to the display screen (vertically long).

Sustain discharge takes place as a surface discharge. When focusing on a single discharge, the discharge is started in the vicinity of the discharge gap formed by the X and Y electrodes in which the field intensity of the discharge space is the highest. After the start of the discharge, the charges of polarity opposite to the electrode potential are sequentially attached from the vicinity of the display gap. Then, the discharge spreads away from the discharge gap. At this time, when the space is vertically long, the sustain discharge can easily spread to the priming discharge cell, so that the MgO surface of the priming discharge cell is likely to be degraded.

For this reason, it is important to optimize the size and shape of the space between the priming discharge cell and the sustain discharge cell. This makes it possible to prevent the degradation of the MgO surface of the priming discharge cell due to spread of the sustain discharge, while supplying an appropriate amount of priming particles from the priming discharge cell to transfer the discharge. As a result, it is possible to accelerate the address discharge triggered by the priming particles, which enables improvement of the time-dependent degradation of discharge delay.

Hereinafter specific embodiments will be described.

### First Embodiment

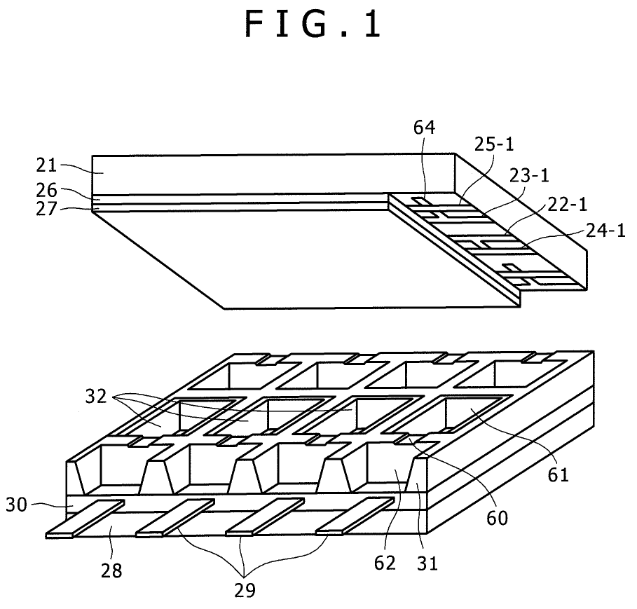

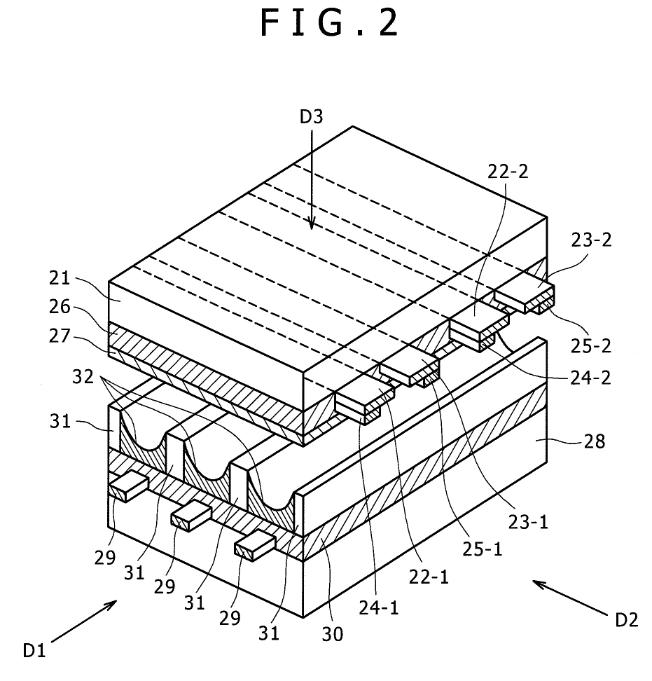

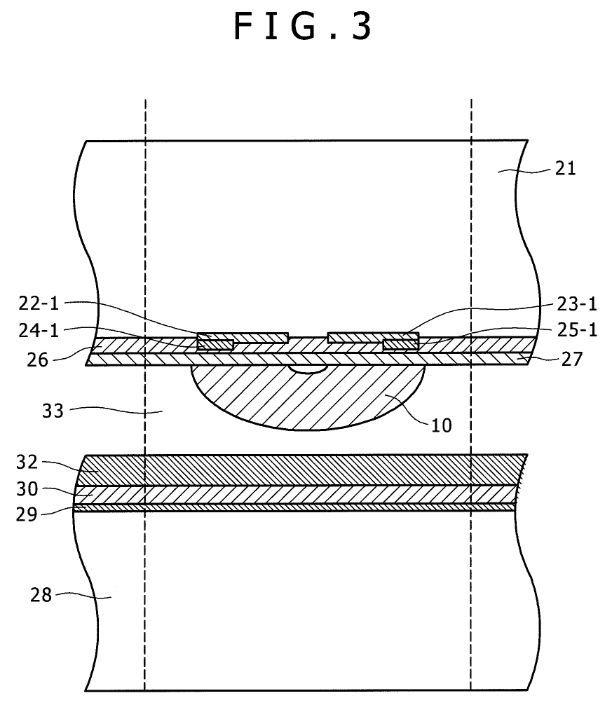

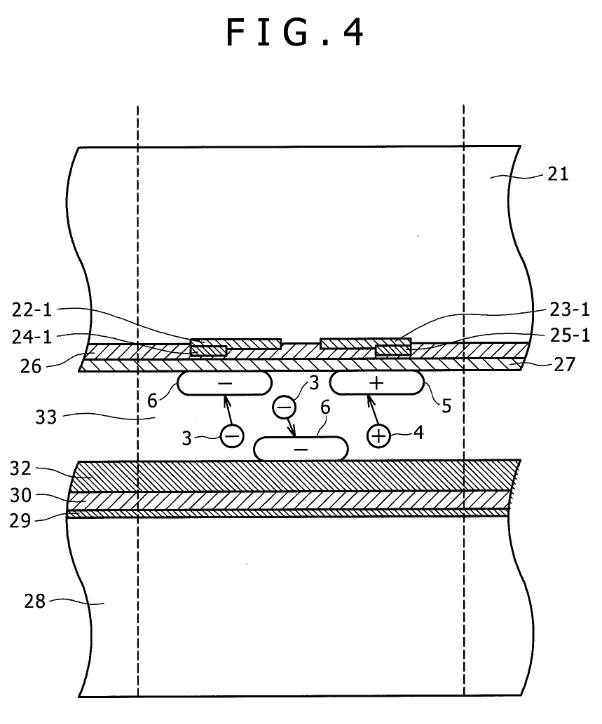

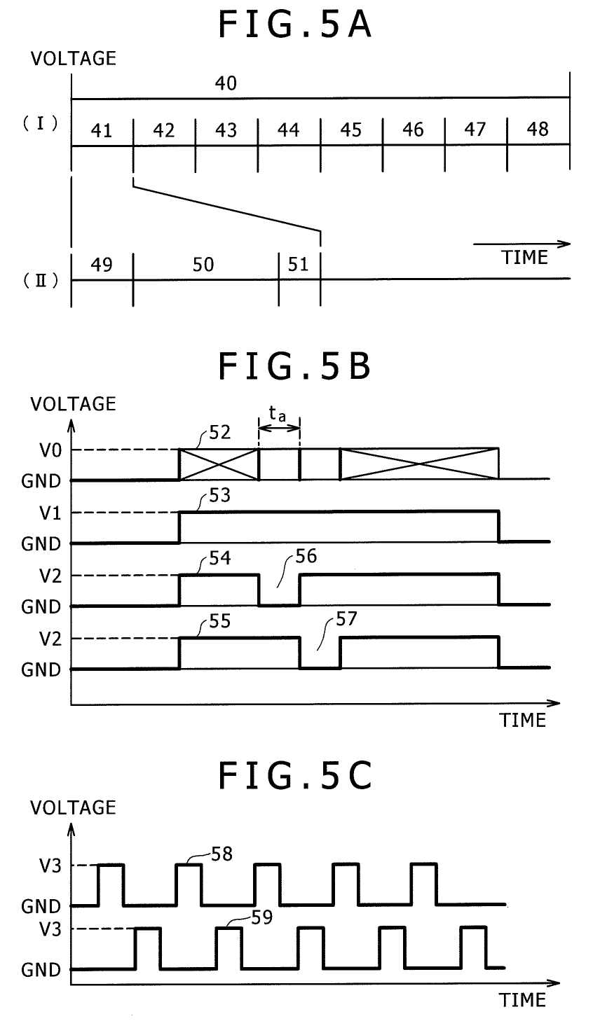

FIG. 1 is an exploded perspective view showing, by way of example, a part of a structure of an embodiment according to the present invention. The study has been performed using a 50-inch full HD (1920×1080 pixels) with a cell pitch of 580 μm vertical and 192 μm horizontal.

A front substrate 21 has an X bus electrode 25-1 and a Y bus electrode 25-1. A pair of sustain-discharge electrodes (an X electrode 22-1 and a Y electrode 23-1 arranged parallel in the lateral direction of the bus electrodes) forms a display line. A protruding electrode 64 extends from the Y bus electrode 25-1 to the side of a priming discharge cell 62. There are also provided a dielectric layer 26 covering the electrodes, and a protective layer 27 mainly containing magnesium oxide to cover the dielectric layer 26.

A back substrate has address electrodes 29 and a dielectric layer 30 covering the address electrodes. The back substrate is divided into discharge cells by ribs 31 to form pixels. Each discharge cell has a pair of a sustain discharge cell 61 and a priming discharge cell 62 with a predetermined space 60 provided therebetween.

A method for forming the space 60 will be described. In this embodiment, sandblasting is used for the formation of ribs. Rib paste is printed, and a sandblasting resist is applied. At this time, only a resist for space is first applied to create a groove for forming the space. Then, a resist for both the sustain discharge cell 61 and the priming discharge cell 62 is applied over the groove to form the respective discharge cells. As described above, the ribs are formed by means of sandblasting in this embodiment, but the method is not particularly limited to sandblasting. It is also possible to form the ribs by a photosensitive material or a molding method.

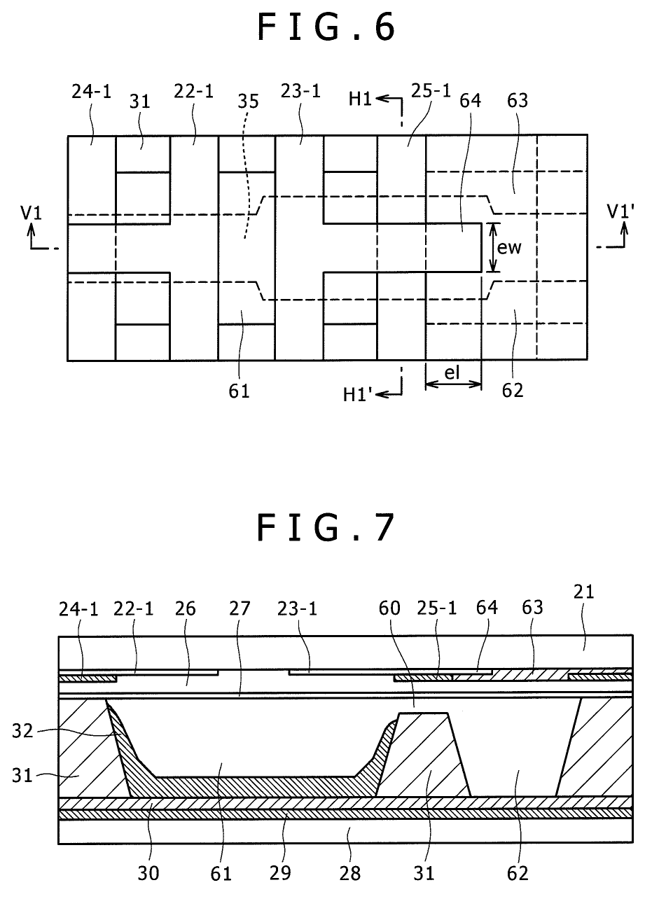

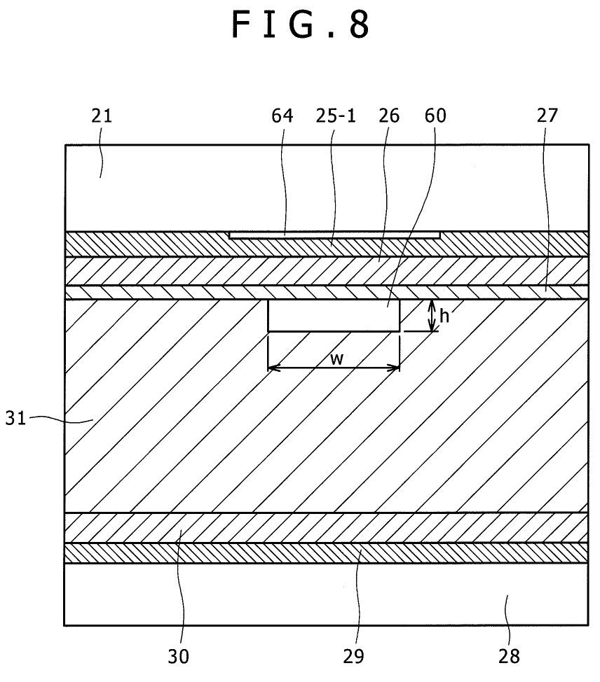

The PDP shown in FIG. 1 will be described in detail using cross-sectional views. FIG. 6 is a view of the structure of a single cell in FIG. 1, viewed from the direction of the display screen. FIG. 6 shows an example of an embodiment according to the present invention, showing a pair of the sustain discharge cell 61 and the priming discharge cell 62. FIG. 7 is a cross-sectional view taken along line V1-V1′ of FIG. 6. FIG. 8 is a cross-sectional view taken along line H1-H1′ of FIG. 6.

As shown in FIG. 6, the priming discharge cell 62 has a black matrix (absorption layer) 63 for preventing unwanted light emission to improve the contrast. The Y electrode 23-1 extends from the sustain discharge cell 61 to the side of the priming discharge cell 62. The extension of the electrode to the side of the priming discharge cell helps to generate address discharge in the priming discharge cell. In this embodiment, only the Y electrode 23-1 is extended, but the Y-bus electrode 25-1 can be extended instead of the Y electrode-23-1, or the two electrodes can be extended as well.

As shown in FIG. 8, the width of the space 60 is given by w and height by h. Here, the study has been performed by setting w to 70 μm and by changing the height h from 0 μm to 60 μm. At this time, in the planar shape of the electrode extending from the sustain discharge cell to the priming discharge cell shown in FIG. 6, the width ew is set to 90 μm and the length el is set to 100 μm.

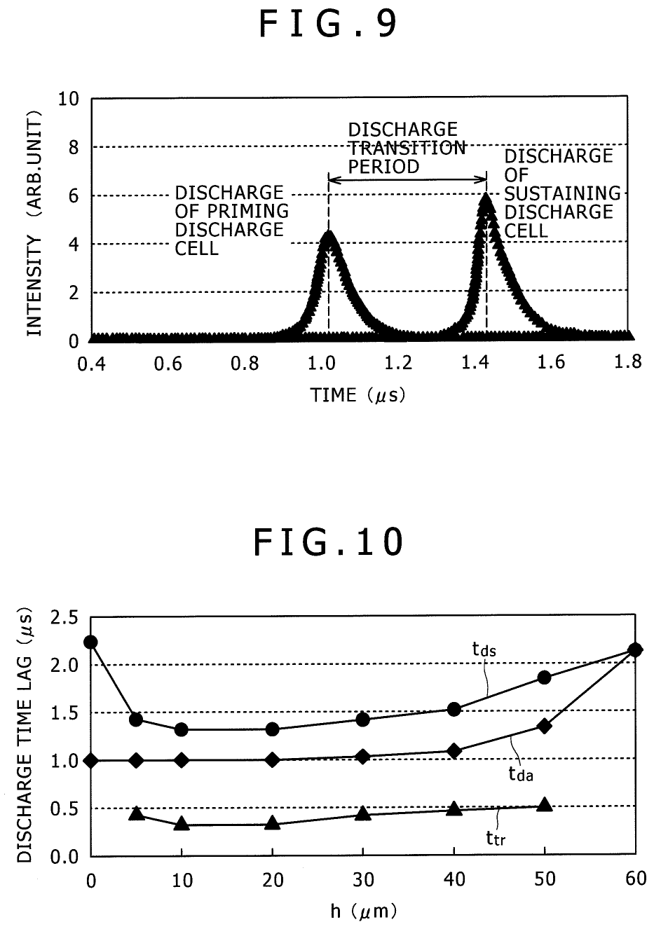

FIG. 9 shows an example of the results of observing the discharge of priming discharge cell and the discharge of sustain discharge cell, when h is set to 30 μm. This is the results of a panel lifetime test of 10000 hours. In the figure, the abscissa represents the time from the raising of an address pulse, and the ordinate represents the discharge emission intensity. Infrared emission from the plasma was used as a probe to observe the discharge emission intensity. From the results shown in the figure, a light emission from the priming discharge cell was observed at about 1 μs, and a light emission from the sustain discharge cell was observed at about 1.45 μs. This shows a state that the priming discharge cell first emits light, and the priming particles are transferred to the sustain discharge cell, and then the sustain discharge cell is triggered by the priming particles to emit light.

On the other hand, when the space is not provided, the priming particles are not introduced to the sustain discharge cell from the priming discharge cell. In this case, the discharge of the sustain discharge cell occurs more slowly at 2.2 μs. From this, it is understood that the discharge of the sustain discharge cell is accelerated by about 0.75 μs due to the effect of the introduction of the priming particles. As shown in FIG. 9, the discharge transition period is the time from when the priming discharge cell discharges, and to when the sustain discharge cell discharges. In this condition, the discharge transition period is found to be 0.45 μs.

As described above, the discharge transition period is dependent on the size and shape of the space. FIG. 10 shows the results of measuring the discharge time lag of priming discharge cell (t_{da}), the discharge time lag of sustain discharge cell (t_{ds}), and the discharge transition period (tₜᵣ), by setting w to 70 μm and by changing the height h from 0 μm to 60 μm. The figure shows the results of the panel lifetime test of 10000 hours. When h=0 μm, the discharge time lag of the sustain discharge cell is not changed, regardless of the occurrence of the discharge in the priming discharge cell. In other words, no introduction of priming particles occurs, so that no discharge transition occurs. In the figure, it is found that when the height h of the space is increased to 5 μm and 10 μm, the discharge transition period (tₜᵣ) decreases and the discharge time lag of sustain discharge cell (t_{ds}) is reduced.

When the height h of the space is further increased from 20 μm to 30 μm, the discharge transition period (tₜᵣ) rather increases due to the following reasons. When the height h of the space is increased, the particles generated in the priming discharge cell erase the charges formed by the reset discharge in the sustain discharge cell. The effective potential applied to the sustain discharge cell decreases. As a result, the time for the discharge formation in the sustain discharge cell increases, and thus the discharge transition period increases.

When the height h of the space is further increased from 30 μm to 60 μm, the discharge transition period (tₜᵣ) slows down, but rather the discharge time lag of priming discharge cell (t_{da}) slows down more than the discharge transition period (tₜᵣ). Particularly, when h=60 μm, the discharge time lag of priming discharge cell and the discharge time lag of sustain discharge cell are the same. From this, it is understood that there is no effect of speeding up the address discharge delay by the priming discharge cell.

This is due to the following reasons. From the results of discharge observation, the sustaining discharge has spread even to the priming discharge cell when the space is too wide. This degrades the MgO surface of the priming discharge cell, leading to degradation of the time lag of priming discharge cell in addition to the discharge time lag of sustain discharge cell. As a result, there is no effect of improving the time-dependent degradation of discharge delay in the sustain discharge cell. In addition, as a result of examination of disassembled panel, discharge traces were observed on the MgO surface of the priming discharge cell. From this, it is understood that the priming discharge cell has been subjected to a heavy discharge.

Consequently, the effective height h of the space was found to be between 5 μm and 50 μm. Further, as it is seen from FIG. 10, the discharge time lag of priming discharge cell (t_{da}) is not degraded at all until h=30 μm. This is because the sustain discharge has not spread to the priming discharge cell until h=30 μm, so that the MgO surface of the priming discharge cell is not degraded. From this, it is understood that the height h ranging from 5 μm to 30 μm is particularly effective.

Next, the width w of the space will be described. The sustain discharge takes place as a surface discharge starting in the vicinity of the discharge gap, and spreads away from the discharge gap as time passes. At this time, when the width of the space is too large, the discharge is likely to spread to the priming discharge beyond the space from the sustain discharge cell. On the other hand, when the width of the space is too small, no priming particles are introduced into the sustain discharge cell from the priming discharge cell, resulting in a lack of priming. In the case of the 50-inch full HD panel, the possible range of w is between 0 μm and 132 μm. From the experimental results obtained by changing the width w from 10 μm, 50 μm, 90 μm, and 130 μm, it has been found that the discharge delay is effectively improved with h ranging from 5 μm to 50 μm. The influence of the discharge spread to the priming discharge cell within the operation margin, can be ignored when w=50 μm and 90 μm. Consequently, it has been found that the time-dependent degradation of discharge delay is effectively improved with w ranging from 50 μm to 90 μm. In this case, it is understood that the cross-sectional area of the space is preferably between 250 μm² and 4500 μm². This is equivalent to from 40% to 70% of the possible range of w in terms of the shape of the space.

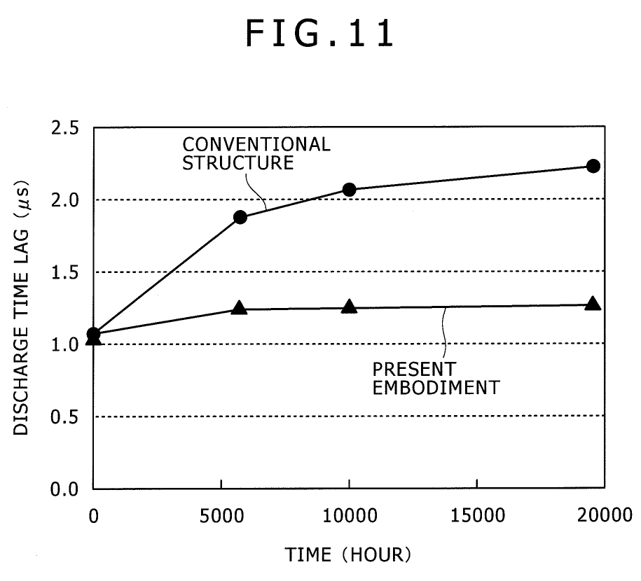

FIG. 11 shows the results of the lifetime test of continuous lightning under the conditions of h=20 μm and w=70 μm in this embodiment. The figure also shows the results of the lifetime test of the 50-inch full HD panel of conventional structure. It is shown that the discharge time lag of this embodiment and the discharge time lag of the conventional structure are the same at 0 hour. The discharge time lag of the conventional structure is degraded over time. On the other hand, the discharge time lag of this embodiment is slightly degraded until 6000 hours, but is hardly degraded until 20000 hours after 6000 hours. This is because MgO of the sustain discharge cell is not degraded at 0 hour, and thus the two discharge time lags are equally short. Then, the discharge time lags are degraded over time. The discharge delay of only the sustain discharge cell in this embodiment is degraded similarly to the conventional structure. However, an increase of the discharge time lag of the sustain discharge cell is suppressed by the introduction of the charged particles from the priming discharge cell. The suppression is less pronounced at 6000 hours, because although the discharge delay of the priming discharge cell is not degraded, a certain amount of time is necessary to transfer the discharge.

From the above results, it has been found that the time-dependent degradation of address discharge delay can be improved by optimizing the space between the sustain discharge cell and the priming discharge cell, to prevent the sustain discharge from spreading to the priming discharge cell.

### Second Embodiment

A similar study was performed using a 50-inch HD (1280×1080 pixels) PDP with a cell pitch of 580 μm vertical and 288 μm horizontal. Like the first embodiment, each discharge cell has a pair of the sustain discharge cell 61 and the priming discharge cell 62 with the predetermined space 60 provided therebetween. The difference between the second embodiment and the full HD PDP of the first embodiment is in the horizontal pitch of each discharge cell. In this embodiment, the w can be set between 0 μm and 228 μm.

The study has been made by changing the height h and width w of the space of the priming discharge cell. As a result, the time-dependent degradation of display delay has been effectively improved with h ranging from 5 to 50 μm and w ranging from 90 to 160 μm. Comparing the results with the case of using the 50-inch full HD panel, the possible range of h is the same both in the 50-inch HD panel and in the 50-inch full HD panel. However, the possible range of w is different in the two cases. Here, considering the size of the cell, the calculation is made to determine the ratio of w to the length of the bus electrode in the longitudinal direction within the effective display area surrounded by the ribs, namely, to the value obtained by subtracting the length of the vertical rib from the horizontal pitch. As a result, it is found that w shows good characteristics when in the range of 40% to 70% of the length of the bus electrode in the longitudinal direction within the effective display area surrounded by the ribs. In other words, the height h of the space of the priming discharge cell is preferably between 5 μm and 50 μm, and the width w of the space thereof is preferably between 40% and 70% of the length of the bus electrode in the longitudinal direction within the effective display area surrounded by the ribs.

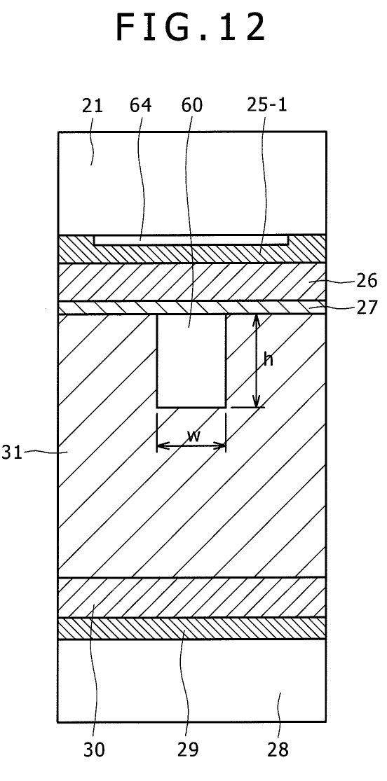

Further, in the case of a 50-inch ultra high definition PDP (for example, 4096×2160 pixels) with a cell pitch of 290 μm vertical and 90 μm horizontal, it can be said that the study results are almost the same as described above. However, as shown in FIG. 12, it may happen that h is larger than w within the range of conditions described above. In this case, the space is vertically long because the width w is small, so that the sustain discharge is likely to spread to the priming discharge cell. For this reason, it is preferable to satisfy the condition w>h, in addition to that the height h of the space of the priming discharge cell is between 5 μm and 50 μm, and that the width w of the space thereof is between 40% and 70% of the length of the bus electrode in the longitudinal direction within the effective display area surrounded by the ribs.

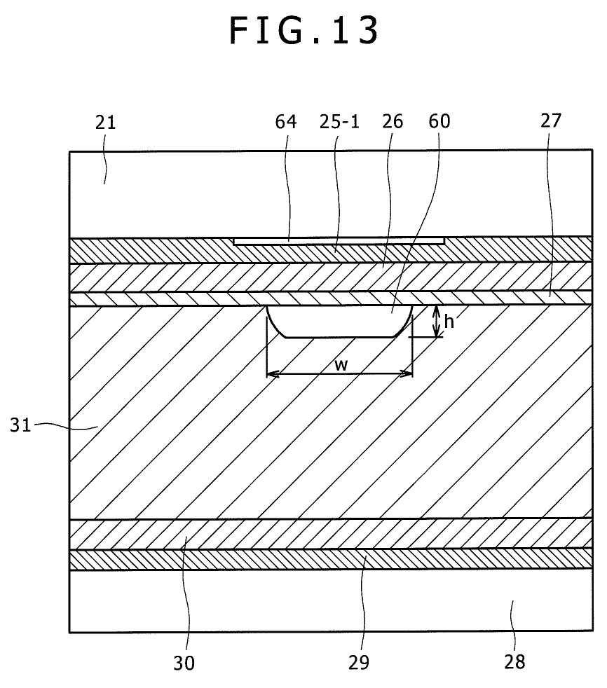

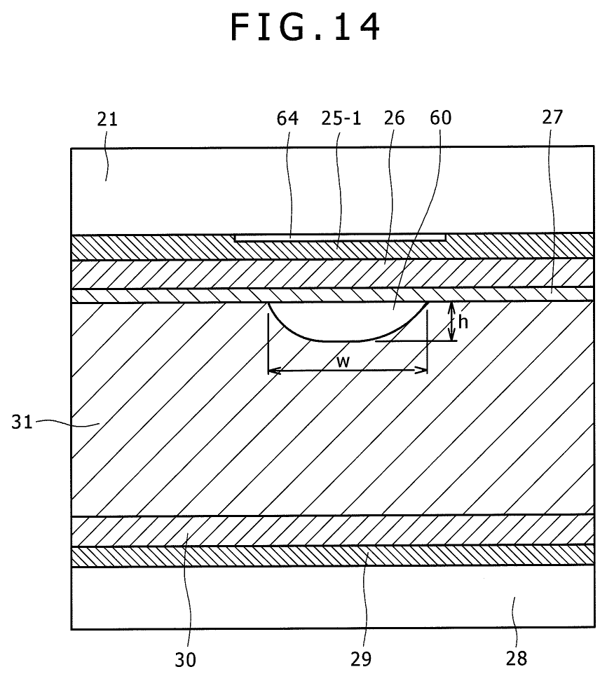

Further, it is apparent that the effect of the space does not vary even if the rectangular shape is slightly rounded as shown in FIGS. 13, 14. The corners of the rectangle may be rounded due to thermal contraction during burning or other factors in the process of rib formation. In this case, as shown in FIGS. 13 and 14, the value of w can be obtained by measuring the space from end to end. In this case also, the cross-sectional area of the space is preferably between 250 μm² and 4500 μm².

Next, the relationship between the protruding electrode 64 and the width w of the space will be described. The sustain discharge takes place as a surface discharge starting in the vicinity of the discharge gap, and spreads away from the discharge gap as time passes. At this time, when the width of the space is larger than the width of the protruding electrode, the discharge is likely to spread to the priming discharge cell through the space. This is because the discharge spreads over time by mainly consuming the wall charges formed around over the electrodes. Thus, the width w of the space is preferably smaller than the width of the protruding electrode 64.

Next, the address discharge in the priming discharge cell will be described. As apparent from Equation (2), the address discharge of the priming discharge cell is preferably fast. For the address discharge, the larger the overlap between the protruding electrode 64 and the projection of the address electrode 35 in the discharge direction, the shorter the discharge delay. Thus, as shown in FIG. 6, by increasing the width of the address electrode in a portion overlapping not only with the Y electrode but also with the protruding electrode 64, the address discharge is accelerated and thus the time-dependent degradation of discharge delay is improved.

Further, as shown in FIG. 6, the priming discharge cell 62 has the black matrix (absorption layer) 63 for preventing unwanted light emission to improve the contrast. From a comparison between with the back matrix 63 and without it, the brightness when displaying black was reduced to about 0.6 times smaller than the case without the black matrix. As a result, the darkroom contrast was increased from 5000:1 to 8000:1.

### Third Embodiment

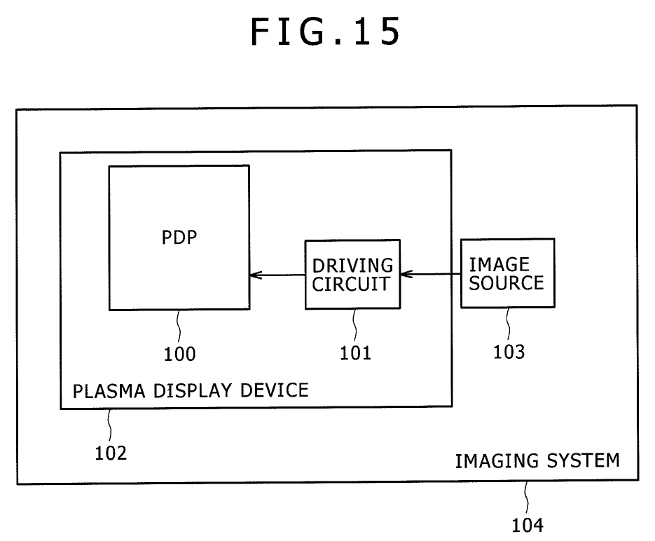

FIG. 15 is a block diagram showing an example of an imaging system having a plasma display device using the PDP described in the above embodiments according to the present invention, and an image source connected to the plasma display device. A driving power (also referred to as a driving circuit) receives display screen signals from the image source, and converts the received signals to PDP driving signals to dive the PDP.

What is claimed is:

1. A plasma display panel comprising:
a front substrate having bus electrodes, and pairs of sustain-discharge electrodes arranged parallel in a lateral direction of the bus electrodes to form display lines;
a back substrate having address electrodes arranged to face the pairs of the sustain-discharge electrodes in the lateral direction of the bus electrodes; and
a plurality of discharge cells formed from the front substrate and the back substrate,
wherein the discharge cell is divided into a sustain discharge cell and a priming discharge cell by a rib, with a predetermined space provided between the rib and the front substrate,
wherein the front substrate has a protruding electrode extending from one of the paired discharge electrodes in the sustain discharge cell or from the bus electrode, to the side of the priming discharge cell through the space, and
wherein the sustain discharge produced in the sustain discharge cell does not spread to the priming discharge cell through the space.

2. The plasma display panel according to claim 1,
wherein a length of the space in the longitudinal direction of the bus electrode is given by w, and a height of the space from the front substrate toward the back substrate is given by h, where w>h, with w between 40% and 70% of an inside diameter of the rib and h between 5 μm and 50 μm.

3. The plasma display panel according to claim 2, wherein h is between 5 μm and 30 μm.

4. The plasma display panel according to claim 1, wherein a width of the protruding electrode in the longitudinal direction of the bus electrode is larger than w.

5. The plasma display panel according to claim 1, wherein the address electrode is formed so as to overlap with projection of the protruding electrode from the front substrate to the back substrate.

6. The plasma display panel according to claim 1, wherein a cross sectional shape of the space is rectangular with smooth corners.

7. The plasma display panel according to claim 1, wherein the protruding electrode extends from the pair of the sustain-discharge electrodes.

8. A plasma display panel comprising:
a front substrate having bus electrodes, and pairs of sustain-discharge electrodes arranged parallel in a lateral direction of the bus electrodes to form display lines;
a back substrate having address electrodes arranged to face the pairs of the sustain-discharge electrodes in the lateral direction of the bus electrodes; and
a plurality of discharge cells formed from the front substrate and the back substrate,
wherein the discharge cell is divided into a sustain discharge cell and a priming discharge cell by a rib, with a predetermined space provided between the rib and the front substrate,
wherein the front substrate has a protruding electrode extending from one of the paired discharge electrodes in the sustain discharge cell or from the bus electrode, to the side of the priming discharge cell through the space, and
wherein a length of the space in the longitudinal direction of the bus electrode is given by w, and a height of the space from the front substrate toward the back substrate is given by h, where w>h, with w between 40% and 70% of an inside diameter of the rib and h between 5 μm and 50 μm.

9. The plasma display panel according to claim 8, wherein h is between 5 μm and 30 μm.

10. The plasma display panel according to claim 8, wherein a width of the protruding electrode in the longitudinal direction of the bus electrode is larger than w.

11. The plasma display panel according to claim 8, wherein the address electrode is formed so as to overlap with projection of the protruding electrode from the front substrate toward the back substrate.

12. The plasma display panel according to claim 8, wherein a cross sectional shape of the space is rectangular with smooth corners.

13. The plasma display panel according to claim 8, wherein the protruding electrode extends from the pair of the sustain-discharge electrodes.

14. The plasma display panel according to claim 1, wherein a black absorption layer is provided in the priming discharge cell on the side of the front substrate.

15. A plasma display panel comprising:
a front substrate having bus electrodes, and pairs of sustain-discharge electrodes arranged parallel in a lateral direction of the bus electrodes to form display lines;
a back substrate having address electrodes arranged to face the pairs of the sustain-discharge electrodes in the lateral direction of the bus electrodes; and
a plurality of discharge cells formed from the front substrate and the back substrate,
wherein the discharge cell is divided into a sustain discharge cell and a priming discharge cell by a rib, with a predetermined space provided between the rib and the front substrate,
wherein the front substrate has a protruding electrode extending from one of the paired discharge electrodes in the sustain discharge cell or from the bus electrode, to the side of the priming discharge cell through the space, and
wherein a length of the space in a longitudinal direction of the bus electrode is given by w, and a height of the space from the front substrate toward the back substrate is given by h, where w>h, with the cross-sectional area of the space ranging between 250 μm² and 4500 μm².

16. The plasma display panel according to claim 15, wherein h is between 5 μm and 50 μm.

17. The plasma display panel according to claim 15, wherein h is between 5 μm and 30 μm.
